(19) United States
(12) Patent Application Publication
(10) Pub. No.: US 2020/0003158 A1
(43) Pub. Date: Jan. 2, 2020

(54) PULSE COMBUSTOR PERFORMANCE IMPROVEMENT WITH AIRSPEED

(71) Applicant: North American Wave Engine Corporation, College Park, MD (US)

(72) Inventor: Daanish MAQBOOL, Hyattsville, MD (US)

(21) Appl. No.: 16/455,295

(22) Filed: Jun. 27, 2019

Related U.S. Application Data
(60) Provisional application No. 62/691,393, filed on Jun. 28, 2018.

(51) Int. Cl. F02K 7/02; F02C 7/04; F02C 7/22; F02C 7/264; F02K 1/82; B64D 33/02

(52) U.S. Cl. CPC F02K 7/02; F02C 7/04; F02C 7/22; F02C 7/264; B64D 33/08; B64D 33/02; F05D 2220/80; B64D 2033/0273; F02K 1/822

(57) ABSTRACT

A system and method is disclosed for improving the performance of pulsejet engines and of flight vehicles that incorporate pulsejet engines as a propulsion system. The system and method will decelerate the oncoming airstream to which a U-shaped pulsejet engine that is the propulsion system for a flight vehicle is exposed so that larger amounts of atmospheric air will be ingested into a rearward-facing inlet pipe for improved engine operation at low and high speeds/altitudes. The system and method provide for the recovery of the dynamic pressure of the incoming fresh airstream to raise the static pressure around the rearward facing inlet pipe to generate higher pressures and higher air density for improving the ingestion of air mass into the inlet pipe of the pulsejet engine thereby producing greater engine power and thrust.

### CROSS-REFERENCES TO RELATED APPLICATIONS

This Application claims the benefit under 35 U.S.C. 119 (e) to U.S. Provisional Patent Application No. 62/691,393, filed Jun. 28, 2018, the entirety of which is explicitly incorporated by reference herein.

All publications, patent applications, patents, or other references mentioned herein are incorporated by reference in their entirety. The patent and scientific literature referred to herein establishes knowledge that is available to those skilled in the art. The issued patents, applications, and other publications that are cited herein are hereby incorporated by reference to the same extent as if each was specifically and individually indicated to be incorporated by reference. In the case of inconsistencies, the present disclosure will prevail.

### FIELD OF THE INVENTION

The present invention generally relates to combustors and jet engines. More specifically, the present invention relates to pulse combustors and/or pulsejet engines and their control systems and methods of operation.

### BACKGROUND OF THE INVENTION

Conventional valveless-type pulse combustors may also be referred to as pulsejet engines. Pulse combustors have been commonly referred to as “pulsejet” or “pulse jet” engines when used for thrust production. Pulsejet engines have a long history and have been used to propel several different aircraft over the last century. Pulsejet engines typically will include a combustion chamber, an inlet pipe, one or more fuel injector(s), a spark plug or other ignition device, and an exhaust pipe that frequently is referred to as a “tailpipe.” However, many of these historical systems did not efficiently consume fuel, were unreliable in operation, and did not necessarily have control systems that made them commercially viable.

Referring to FIG. 1, generally at 100, a representative conventional straight pulsejet engine is shown that is longitudinally sectioned to show the interior. The pulsejet engine at 100 includes inlet pipe 104 and exhaust pipe 110 that connect to combustion chamber 102. The pulse combustor also includes fuel injector 106 and spark plug 108.

Again referring to FIG. 1, fuel injector 106 is shown located so that it can inject fuel into the interior of inlet pipe 104. Spark plug 108 is shown located in a position with respect to combustion chamber 102 so that it can provide sparks for igniting at least the first fuel-air mixture introduced into combustion chamber 102 for starting the pulsejet engine.

When the pulsejet engine shown at 100 is to be started, air is forced into inlet pipe 104, and this air will mix with fuel being injected from fuel injector 106. According to the control of the pulsejet engine, the fuel-air mixture is ignited by sparks from spark plug 108 to start the engine. The combustion causes a rise in the temperature and pressure of the gases within combustion chamber 102. The ignited gases expand and escape through inlet pipe 104 and exhaust pipe 110. The high velocity of the escaping gases caused by the overexpansion of the gases will cause negative pressure within combustion chamber 102. This negative pressure will reverse the direction of the fluid flow in inlet pipe 104 and exhaust pipe 110. Fresh atmospheric air will be drawn in toward combustion chamber 102 through both inlet pipe 104 and exhaust pipe 110; however, only air being drawn into inlet pipe 104 will reach combustion chamber 102. The air being drawn in through longer length exhaust pipe 110 will not have sufficient time to reach combustion chamber 102 between combustion events.

The fresh air being drawn in through inlet pipe 104 will mix with the fuel that is injected either in inlet pipe 104 or directly into combustion chamber 102. After the pulsejet engine at 100 is started, subsequent fuel-air mixtures entering combustion chamber 102 will encounter high-temperature combustion products from the previous combustion event. These combustion products will ignite the new fuel-air mixture that enters combustion chamber 102 to produce another combustion event and this process will repeat as long as there is sufficient fuel being injected into inlet pipe 104 or directly into combustion chamber 102 to mix with the air that will ingress through inlet pipe 104.

The result of the combustions is that inlet pipe 104 and exhaust pipe 110 produce oscillating hot gas flows, i.e., intermittent jets of gas that produce thrust. Exhaust pipe 110 usually produces the greatest amount of thrust, but the inlet pipe also contributes a significant amount of thrust. The order of magnitude of thrust being produced from the inlet and exhaust pipes is approximately two-fifths (⅖) and three-fifths (⅗), respectively.

For most static applications, the opposite directions of thrust being output from inlet pipe 104 and exhaust pipe 110, respectively, does not matter; however, if the pulse combustor is being used as a propulsion system for vehicles (flight or land), it is advantageous for inlet pipe 104 and exhaust pipe 110 to direct their thrust in the same direction.

In order to make the most effective use of the thrust for (flight or land) vehicle propulsion, it is preferable for the thrust from inlet pipe 104 and exhaust pipe 110 to be additive. One way to do this is for exhaust pipe 110 to be turned to point in the same direction as inlet 104 (or vice versa) as shown in FIG. 2. FIG. 2 will now be discussed.

Referring to FIG. 2, generally at 200, a representative U-shaped pulsejet engine is shown that is longitudinally sectioned to show the interior. A conventional pulse combustor or pulsejet engine of this type includes inlet pipe 204 and exhaust pipe 210 facing in the same direction. Except for the U-shape, the components of this pulsejet engine operate substantially the same as their counterparts shown in FIG. 1. That is, combustion chambers 102 and 202, inlet pipes 104 and 204, fuel injectors 106 and 206, spark plugs 108 and 208, and exhaust pipes 110 and 210, respectively, operate substantially the same. The advantage of the U-shaped pulsejet engine is that for purposes of propulsion, all the thrust is directed in the same direction.

Again referring to FIG. 2, when starting the pulsejet engine, a fuel-air mixture is introduced into combustion chamber 202, and then spark plug 208 generates a spark to ignite the fuel-air mixture. The resulting combustion causes a rise in the temperature and pressure of the gases within combustion chamber 202. The ignited gases expand and escape through inlet pipe 204 and exhaust pipe 210. As before, the high velocity of the escaping gases caused by the overexpansion of the gases causes negative pressure within combustion chamber 202. This negative pressure will reverse the direction of the fluid flow in inlet pipe 204 and exhaust pipe 210. Fresh atmospheric air will be drawn toward combustion chamber 202 through both inlet pipe 204 and exhaust pipe 210. However, only air being drawn into inlet pipe 204 will reach combustion chamber 202 for the reasons discussed with respect to the straight pulse combustor shown in FIG. 1 at 100.

After the pulsejet engine has been started, each new fuel-air mixture that is drawn into combustion chamber 202 will be ignited by the residual high-temperature combustion products from the previous combustion event. This process repeats as long as there is sufficient fuel being injected to mix with the air to form fuel-air mixtures for introduction into combustion chamber 202. The intermittent jets of gas that are generated and output from inlet pipe 204 and exhaust pipe 210 direct all of the thrust in one direction for propelling a (flight or land) vehicle in the direction of the thrust.

Pulsejet engines are characterized by their simplicity because of their lack of moving parts. However, when used in a forward airspeed environment, i.e., in a flight vehicle, U-shaped pulsejet engines have difficulty being able to effectively utilize the velocity of the oncoming air. As described by Bernoulli's principles, and as is common in air-breathing jet engines, the velocity of the oncoming airstream can be reduced to increase the air pressure and density, which is beneficial for engine power and thrust. This increased air pressure arising from the vehicle velocity is also sometimes referred to as “ram” air pressure.

In a pulsejet, it can be difficult to make use of ram air pressure because inlet pipe 204 is pointed away from the incoming (ram) airstream (see for example FIGS. 3 and 4). More specifically, if the pulsejet engine is disposed in a flight vehicle such that inlet pipe 204 is rearward facing as shown in FIG. 4, it can be difficult for the engine to ingest a large amount of air into inlet pipe 204 that is desired because the fresh airstream has to be turned 180° as shown in FIGS. 3 and 4. The result is that the pulsejet engine can be starved of the proper amount of air to mix with the fuel being injected for maintaining sustained operation, unless there is some type of air pumping mechanism to provide air to the inlet pipe. To do this would require the introduction of additional parts/modules to the pulsejet engine thus complicating the system and potentially making it less reliable because of the susceptibility of these additional parts to fail.

Therefore, it is highly desirable for there to be systems and methods for overcoming at least the problems of: providing systems and methods for improving the thrust and power of pulsejet engines; being able to effectively utilize ram air pressure when the pulsejet engine is configured such that the inlet pipe has a rearward orientation like the exhaust pipe; ingesting an appropriate amount of fresh air into the inlet pipe when that air has to be turned 180° to enter the inlet pipe; and cooling the material/shell temperature of the pulsejet engine, which can be at high temperatures during operation, so that reliable, sustained operation of a pulsejet engine can be achieved for flight vehicles at low and high speeds/altitudes.

### SUMMARY OF THE INVENTION

The present invention is directed to systems and methods for improving the efficient operation of flight vehicles that use pulsejet engines as a primary or secondary propulsion system by improving engine performance with airspeed, while retaining the ability to cool such engines. According to the present invention, system and methods are provided to decelerate the velocity of the oncoming airstream encountered by a pulsejet engine that is used as the propulsion system for a flight vehicle so that sufficiently large amounts of atmospheric air can be ingested in the inlet pipe for sustained engine operation at low and high speeds/altitudes even though the fresh air has to be turned approximately 180° to enter the inlet pipe. The system and method of the present invention provides for the recovery of the dynamic pressure of the incoming fresh airstream to raise the static pressure around the open end of a rearward facing inlet pipe with the result being higher pressures and air density around the inlet pipe for improving the ingress of air into this pipe, thereby generating greater power and thrust for the pulsejet engine.

In an embodiment of the present invention, the “U-shaped” pulsejet engine will include a shroud that encases the inlet pipe, the combustion chamber, and a portion of the exhaust pipe. The shroud encasing portions of the pulsejet engine is considered an aerodynamic fluid duct that has the ability to act as a diffuser. For purposes of the present invention, the terms “shroud,” “diffuser,” and “diffuser duct” shall have the same meaning.

The front end of the diffuser duct opens in the direction of the oncoming airstream. Preferably, the diffuser duct is circular in cross-sectional shape with increasing diameters along its length from the forward to rearward ends. The diameter at the front opening of the diffuser duct is small compared to the diameter of the rear opening of the diffuser duct. Thus, according to the principles of fluid mass conservation, Bernoulli principles and the Venturi effect, the air expanding from the smaller diameter tubular section at the front of the diffuser duct to the larger diameter middle section to the even larger diameter distal end of the diffuser duct will result in an increase in air pressure and a decrease in airspeed.

When a flight vehicle uses a U-shaped pulsejet engine with a diffuser duct according to the present invention, the diffuser duct receives the incoming fresh airstream. The diffuser duct decelerates the velocity of the airstream to produce an airflow around the open distal end of the inlet pipe that is at a lower velocity and higher static pressure. The lower air velocity is a first feature to provide better conditions for large amounts of air to make the 180° turn to enter the inlet pipe. A second feature is the higher static pressure and density of the air in the diffuser duct will help push more air mass through the inlet pipe and into the combustion chamber. This allows more fuel to be combusted to release more energy and produce more thrust. Another feature of the present invention is that the air in the diffuser that passes around portions of the U-shaped pulsejet engine helps dissipate heat and cool the engine.

The deceleration of the air in the diffuser duct will be controlled by the diameters of the tubular front section, middle section, and rear section of the diffuser duct. The diffuser duct may have a circular front-on cross-sectional shape or have other front-on cross-sectional shape. The cross-sectional shape of the diffuser duct along its length can be adjusted to provide an optimal pressure and velocity profile for powering the pulsejet engine. All of these combined effects result in an increase in the amount of thrust and power that the engine will produce for the forward propulsion of a flight vehicle.

The present invention is directed to systems and methods for preferably improving operation of U-shaped engine propulsion systems used for powering flight vehicles that are capable of being operated at low and high speeds/altitudes. The systems include a pulsejet and a diffuser. The diffuser can be integrated as part of the flight vehicle structure.

The pulsejet has at least a combustion chamber; an inlet pipe having a first length and connected to, and in fluid communication with, the combustion chamber, with the proximal end of the inlet pipe being connected to the combustion chamber and an open distal end pointed in first direction, with the inlet pipe for an ingress of air for transmission to the combustion chamber and an output of thrust-producing gases after combustions in the combustion chamber; an exhaust pipe having a second length longer than the first length and connected to, and in fluid communications with, the combustion chamber, with a proximal end of the exhaust pipe being connected to the combustion chamber and an open distal end pointed in the first direction, with the exhaust pipe for an output of thrust-producing gases after combustions in the combustion chamber; at least one fuel injector connected to the inlet pipe or combustion chamber for the injection of fuel into air input to the combustion chamber; and a spark generating means connected to the combustion chamber for the generation of sparks to ignite fuel-air mixtures input to the combustion chamber to produce combustions for a production of thrust-producing gases for output from the input pipe and exhaust pipe.

The diffuser has a front section, middle section, and rear section, with the diffuser encasing at least the combustion chamber and inlet pipe, with each section having a predetermined cross-sectional shape, and further with the front section having a first cross-sectional area, the middle section having a second cross-sectional area larger than the first cross-sectional area, and the rear section having a third cross-sectional area greater than the second cross-sectional area, and further with the diffuser being capable of reducing the velocity of an airstream input to the diffuser through the front section and transiting to the rear section during operation of the flight vehicle at low and high speeds/altitudes so that a predetermined amount of air can ingress the inlet pipe for mixing with the fuel being injected by the fuel injector.

The front section, middle section, and rear section of the diffuser have a predetermined cross-sectional shape. The diffuser has a form in which the front section transitions to the wider middle section in a predetermined manner and the middle section transitions to the wider rear section in a predetermined manner. The form of the diffuser also increases a level of static pressure in the diffuser in a predetermined manner as air transits from the front section to the rear section for enhancing an ability of the predetermined amount of air to ingress the inlet pipe. Further, the form of the diffuser decreases the velocity of the airstream input to the front section in a predetermined manner as air transits from the front section to the rear section so that a predetermined amount of air will ingress the inlet pipe by substantially reversing the direction of the predetermined amount of air flow from the first direction to a second direction. The first direction is toward a rearward end of the flight vehicle.

The cross-sectional shape of the front section, middle section, and rear section of the diffuser includes a circular or an oval cross-sectional shape. The open distal end of the rear section of the diffuser has connected thereto a deformable extension capable of changing the cross-sectional area of the open end of the rear section for adjusting the level of static pressure within the diffuser.

Noting the foregoing, the present invention overcomes problems of the past for U-shaped pulsejet engines that are used for powering land or flight vehicles with their inlet pipes and exhaust pipes pointed in the same direction. The present invention will result in increased amounts of fresh air being provided to the pulsejet engine through the inlet pipe for efficient sustained engine operation and providing increased amounts of power and thrust. Further, the present invention overcomes the problem of providing methods to control the high material/shell temperatures of a pulsejet engine and dissipating heat.

The systems and methods of the present invention will be described in more detail in the remainder of this specification with reference to the drawings.

### BRIEF DESCRIPTION OF THE DRAWING(S)

FIG. 1 shows a representative conventional straight pulsejet engine that is longitudinally sectioned to show the interior (PRIOR ART).

FIG. 2 shows a representative U-shaped pulsejet engine that is longitudinally sectioned to show the interior (PRIOR ART).

FIG. 3 shows a representative embodiment of the present invention that includes a diffuser duct encasing at least portions of pulsejet engine.

FIG. 4 shows a representative embodiment of the present invention that includes a diffuser duct encasing at least portions of a pulsejet engine with the diffuser duct being integrated as part of a flight vehicle structure.

### REFERENCE NUMERALS IN THE DRAWING(S)

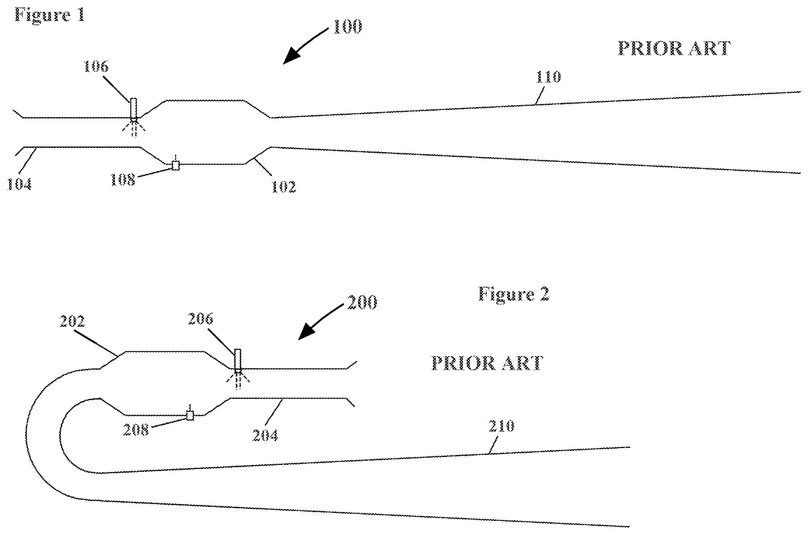

The following are the reference numbers that are used in FIGS. 1-4:

FIG. 1

| | |
|---|---|
| 100 | Longitudinally sectioned |
| | conventional straight pulsejet |
| | engine (PRIOR ART). |
| 102 | Combustion Chamber |
| 104 | Inlet Pipe |
| 106 | Fuel Injector |
| 108 | Spark Plug |
| 110 | Exhaust Pipe |

FIG. 2

| | |
|---|---|
| 200 | Longitudinally sectioned |
| | conventional U-shaped pulsejet |
| | engine (PRIOR ART). |
| 202 | Combustion Chamber |
| 204 | Inlet Pipe |
| 206 | Fuel Injector |
| 208 | Spark Plug |
| 210 | U-shaped Exhaust Pipe |

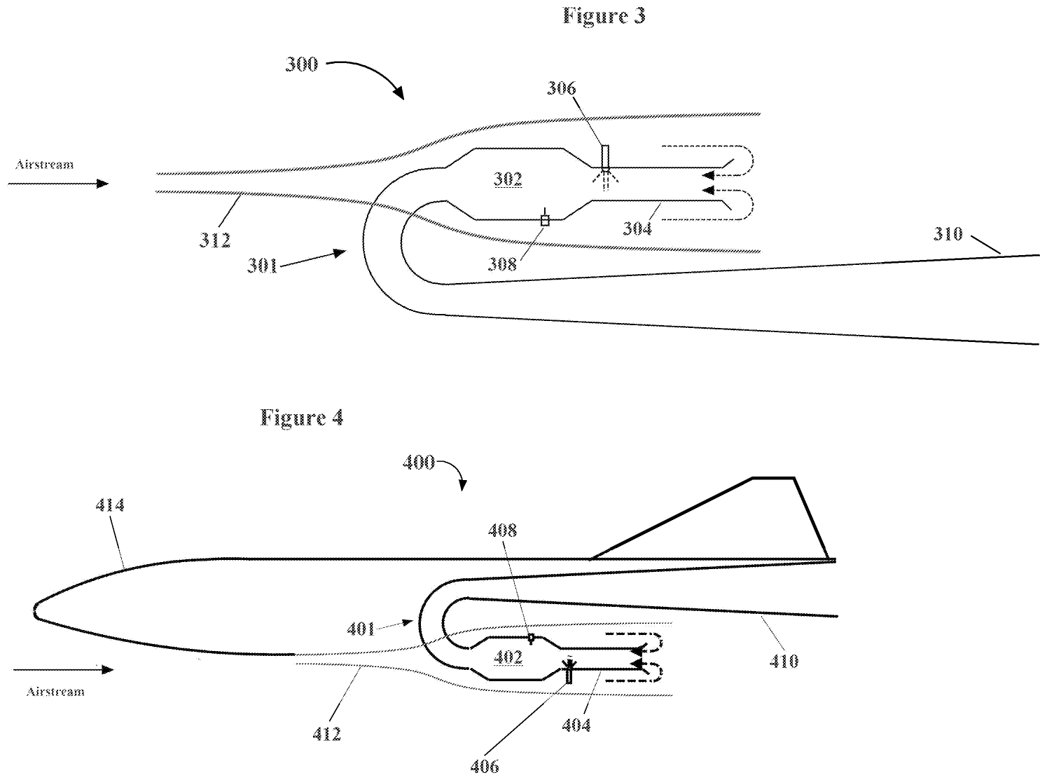

FIG. 3

| | |
|---|---|
| 300 | Longitudinally sectioned U-shaped |
| | pulsejet engine with portions |
| | encased in a diffuser duct |
| 301 | U-shaped Pulsejet Engine |
| 302 | Combustion Chamber |
| 304 | Inlet Pipe |
| 306 | Fuel Injector |
| 308 | Spark Plug |
| 310 | Exhaust Pipe |
| 312 | Diffuser Duct |

FIG. 4

| | |
|---|---|
| 400 | Flight vehicle structure that |
| | includes a longitudinally sectioned |
| | U-shaped pulsejet engine with |
| | portions encased in a diffuser duct |
| | that is part of the flight vehicle |
| | structure |
| 401 | Pulsejet Engine |
| 402 | Combustion Chamber |
| 404 | Inlet Pipe |
| 406 | Fuel Injector |
| 408 | Spark Plug |
| 410 | Exhaust Pipe |
| 412 | Diffuser Duct |
| 414 | Flight Vehicle Structure |

### DETAILED DESCRIPTION OF THE INVENTION

The present invention is directed to systems and methods for improving the airspeed performance of pulsejet engines and flight vehicles that incorporate pulsejet engines as a propulsion system. When a U-shaped pulsejet engine is used as the propulsion system for a flight vehicle, system and methods of the present invention are used to improve the power and thrust of the engine by decelerating the velocity of the oncoming ram airstream to which the pulsejet engine will be exposed so that the engine will be able to ingest sufficiently large amounts of atmospheric air through its rearward facing inlet pipe even though the fresh air from the airstream has to turn approximately 180° to enter the inlet pipe. The system and method of the present invention also provide for the recovery of the dynamic pressure of the incoming fresh air from the oncoming airstream to raise the static pressure around the rearward facing inlet pipe to generate higher pressure and air density around the inlet pipe opening. This will allow the inlet pipe (and therefore, the pulsejet engine) to ingest larger mass amounts of air. Ingestion of larger mass amounts of air will also allow more fuel to be injected and combusted, to produce greater engine power and thrust. Thus, the present invention allows for increased engine power and thrust with airspeed, while also allowing for cooling of the material/shell of the pulsejet engine, which can otherwise experience high temperatures during operation.

In this specification, it is understood that the following terms shall be interpreted as follows: “pulse combustor,” “pulse jet engine,” “pulse jet,” “pulsejet engine,” or “pulsejet” are all meant to refer to the same device. It is further understood that a pulsejet or pulsejet engine is a pulse combustor that is used for thrust production.

Referring to FIG. 3, generally at 300, a longitudinal section view of an embodiment of the present invention is shown. According to FIG. 3, pulsejet engine 301 preferably includes inlet pipe 304 that connects to combustion chamber 302. Combustion chamber 302 also connects to exhaust pipe 310. Pulsejet engine 301 also includes one or more fuel injector(s) 306 of which only one is shown in FIG. 3. When multiple injectors are used, they may be located around inlet pipe 304 or combustion chamber 302. In each case, the fuel injectors point inwardly toward the interior of the structure on which they are disposed. However, a person of ordinary skill in the art would understand that the multiple fuel injectors, their locations, quantities, and geometries may be varied and still be within the scope of the present invention.

Regarding the use of fuel injectors with respect to pulsejet engine 301, the fuel injector(s) 306 are connected to a fuel supply, such as, a fuel tank, and fuel pump (not shown), and a pulsejet engine controller (not shown) that will cause fuel to be injected into inlet pipe 304 or directly into combustion chamber 302 according to a computer-based program to control the pulsejet engine controller. It is understood that multiple fuel injectors may be employed according to the system and method of the present invention and these fuel injectors can be selectively opened and closed for purposes of effecting proper pulsejet engine operations.

Again referring to FIG. 3, spark plug 308 is shown located in a position with respect to combustion chamber 302 so that it can provide sparks for igniting a fuel-air mixture in combustion chamber 302 for starting the engine and sustaining engine operation after it has started, if desired. Spark plug 308 may be controlled by the electronic engine controller (not shown). The electronic engine controller will send electrical control signals to spark plug 308. It is within the scope of the present invention that another ignition device(s), such as a glow plug, can also be used for igniting fuel-air mixtures in combustion chamber 302.

It is understood by person of ordinary skill in the art that such an electronic engine controller (not shown) may receive information regarding the state of the pulsejet engine from various sensors placed on/around the pulsejet engine. The electronic engine controller monitors the electrical signals received from the various sensors to control engine operation. Pulsejet engine operation may be under program control through programmed firmware associated with the electronic engine controller, a computer-based device, carried out manually by a human operator through an appropriate computer-based device, or wirelessly from a remote location using an appropriate computer-based device. It is understood that pulsejet engine 301 and 401 (see FIGS. 3 and 4, respectively) may be configured according to what is set forth in U.S. patent application Ser. No. 15/074,609, filed Mar. 18, 2016, and/or U.S. patent application Ser. No. 16/386,386, filed Apr. 17, 2019. As such, these applications are incorporated by reference in their entirety.

Again referring to FIG. 3, when pulsejet engine 301 is to be started, air is forced into inlet pipe 304. This air will mix with fuel being injected from fuel injector 306. According to the control of pulsejet engine 301, the fuel-air mixture is ignited by sparks from spark plug 308. This combustion process causes a rise in the temperature and pressure of the gases in combustion chamber 302. The ignited gases expand and escape through inlet pipe 304 and exhaust pipe 310. The high velocity of the escaping gases causes an overexpansion of the gases, which then causes negative pressure in combustion chamber 302. As stated previously, this negative pressure will reverse the direction of the fluid flow in inlet pipe 304 and exhaust pipe 310. Fresh atmospheric air will be drawn in toward combustion chamber 302 through both inlet pipe 304 and exhaust pipe 310. As previously explained, only the air from inlet pipe 304 will mix with the fuel that is injected either in inlet pipe 304 or directly into combustion chamber 302. After the pulsejet engine has been started, the fuel-air mixtures introduced into combustion chamber 302 will be ignited by residual high-temperature combustion products from the previous combustion event. This process will repeat as long as there is sufficient fuel being injected to mix with the air being drawn in through inlet pipe 304. Given the existence of the residual combustion products after each combustion event, spark plug 306 or other ignition device can be disabled once the engine has started.

Referring to FIG. 3, it shows diffuser duct 312 encasing inlet pipe 304, combustion chamber 302, and a portion of exhaust pipe 310. The front end of the diffuser duct is narrow and preferably has a circular front-on cross-sectional shape. The deceleration of the air in the diffuser duct will be controlled by the diameters of the tubular front section, middle section, and rear section of the diffuser duct according to the principles of fluid mass conservation. The diffuser duct shape may be circular in front-on cross-section shape or have other cross-sectional shapes, which include, for example, an oval front-on cross-sectional shape, and this cross-sectional shape can continue throughout its length as it widens. The cross- and longitudinal-sectional shapes of the diffuser can be adjusted to provide the optimal pressure and airspeed velocity profile for operation of the pulsejet engine. All of these combined effects result in an increase in the amount of thrust and power that the engine will produce for the forward propulsion of a flight vehicle.

As shown in the embodiment of the present invention FIG. 3, moving rearward from the tubular front section of diffuser duct 312, it widens significantly in the middle section and then even becomes even wider at the rear section. The distal end of diffuser duct 312 is shown open with no restrictions; however, it would be understood by a person of ordinary skill in the art that the end of diffuser duct 312 may be shaped to increase or decrease the static pressure in the diffuser duct. In at least one embodiment, the distal end of the rear section of the diffuser duct may be shaped to semi-close the end for changing the static pressure in the diffuser duct. Further, the shaping of the distal end of the rear section may be mechanically controllable so the static pressure profile in the diffuser duct would be tunable. The different shapes of the distal end of diffuser duct 312 can be used to control the pressure and density of the air that needs to enter inlet pipe 304.

In FIG. 3, diffuser duct 312 functions as an aerodynamic diffuser. In a nominal operating condition, the oncoming airstream that enters diffuser duct 312 initially will be at the same velocity as the freestream (vehicle velocity), but will then decelerate as it moves rearward. When this air moves around combustion chamber 302, inlet pipe 304, and portions of exhaust pipe 310 in the wider cross-sectional areas of the middle section and rear section of diffuser duct 312, the pressure of the air will increase and velocity will decrease.

As stated briefly above, the functioning of diffuser duct 312 that encases combustion chamber 302, inlet pipe 304, and a portion of exhaust pipe 310 is according to the principles of fluid mass conservation, Bernoulli principles, and the Venturi effect. The use of these principles dictate that diffuser duct 312 will have a front opening that is small in cross-sectional area compared to the cross-sectional area of the diffuser at the middle section and rear section. The air rapidly expands as it passes from the smaller cross-sectional area of front section of the diffuser duct to the larger cross-sectional area of the middle section to the even larger cross-sectional area of the rear section.

Noting this, diffuser duct 312 carries out at least two functions: it will increase the air pressure and decrease air speed. This higher static air pressure and reduced air velocity will assist in the ingestion of larger mass amounts of air into inlet pipe 304.

In more specificity, there is a higher pressure difference generated across inlet pipe 304 during an intake event and the density of the air to be ingested into inlet pipe 304 is increased. Furthermore, the velocity of the air around the inlet is lowered due to air diffusion, requiring a smaller amount of air acceleration for air ingestion into the inlet pipe 304. These features provide an environment that is more conducive for the ingestion of larger mass amounts of air into inlet pipe 304.

Diffuser duct 312 can also act as a fluid ejector nozzle that is sometimes referred to as an “augmenter” when used in the context of pulsejet engines. In this capacity, it can pump the ambient air in the diffuser duct to produce yet higher thrust and higher engine operational efficiency.

Noting the above, air surrounding the distal end of inlet pipe 304 will: (1) be decelerated; (2) have a higher pressure; and (3) have a higher density, as according to the principle of fluid mass conservation, Bernoulli principles, and the Venturi effect. These factors make it possible for pulsejet engine 301 to ingest a larger mass of air during an intake event. These features will improve the power and thrust of pulsejet engine 301, particularly with higher airspeed, and provide better operational performance of the engine in low and high altitude operations when used in a flight vehicle.

FIG. 4, generally at 400, shows a representative embodiment of the present invention that includes a diffuser duct encasing a U-shaped pulsejet engine and the diffuser duct is integrated as part of a flight vehicle structure. More specifically, FIG. 4 shows pulsejet engine 401 with portions encased by diffuser duct 412, and diffuser duct 412 is integrated into flight vehicle structure 414. The components of pulsejet engine 401 and diffuser duct 412 operate substantially the same as their counterparts shown in FIG. 3. That is, diffuser duct 312 and 412, combustion chambers 302 and 402, inlet pipes 304 and 404, fuel injector(s) 306 and 406, spark plugs 308 and 408, and exhaust pipes 310 and 410, respectively, operate substantially the same.

Again referring to FIG. 4, pulsejet engine 401 is disposed such that it is encased by part of flight vehicle structure 414, namely the diffuser duct 412 portion. The distal end of exhaust pipe 410 exhausts at the rear end of the flight vehicle structure for venting the thrust-producing gas streams. Further, this Figure shows that the distal end of inlet pipe 404 is not only situated in diffuser duct 412 to receive large mass amounts of air for intake events but also situated for venting the thrust-producing gas streams following combustion events.

In embodiments of pulsejet engine 401 and diffuser duct 412 being integrated in a flight vehicle structure such as 414, the front end of diffuser duct 412 can open on top or bottom of the flight vehicle structure or can be in the form of gills or side-, or top- or bottom-oriented scoops that will channel the incoming air into diffuser duct 412. In other embodiments, diffuser duct 412 can surround the entirety of pulsejet engine 401 including the exhaust pipe. In any of these embodiments, the advantages that have been previously described for the present invention will still be provided and the pulsejet engine will operate reliably for low and high speed/altitude operations of the flight vehicle in which it is integrated, have improved power and thrust, and be cooled by the fluid flow through the diffuser duct by efficiently dissipating heat.

It is contemplated that systems, devices, methods, and processes of the disclosure invention encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems of the present disclosure that consist essentially of, or consist of, the recited components, and that there are processes and methods according to the present disclosure that consist essentially of, or consist of, the recited processing steps.

It should be understood that the order of steps or order for performing certain action is immaterial so long as the disclosure remains operable. Moreover, two or more steps or actions may be conducted simultaneously. The mention herein of any publication, for example, in the Background section, is not an admission that the publication serves as prior art with respect to any of the claims presented herein. The Background section is presented for purposes of clarity and is not meant as a description of prior art with respect to any claim.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

Noting the foregoing, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A system for improving operation of a U-shaped engine propulsion system used for powering a flight vehicle that is capable of being operated at low and high speeds/altitudes comprising:
a pulsejet including at least,
a combustion chamber,
an inlet pipe having a first length and connected to, and in fluid communication with, the combustion chamber, with a proximal end of the inlet pipe being connected to the combustion chamber and an open distal end pointed in first direction, with the inlet pipe for an ingress of air for transmission to the combustion chamber and an output of thrust-producing gases after combustions in the combustion chamber,
an exhaust pipe having a second length longer than the first length and connected to, and in fluid communications with, the combustion chamber, with a proximal end of the exhaust pipe being connected to the combustion chamber and an open distal end pointed in the first direction, with the exhaust pipe for an output of thrust-producing gases after combustions in the combustion chamber,
at least one fuel injector connected to the inlet pipe or combustion chamber for an injection of fuel into air input to the combustion chamber, and
a spark generating means connected to the combustion chamber for generation of sparks to ignite fuel-air mixtures input to the combustion chamber to produce combustions for a production of thrust-producing gases for output from the input pipe and exhaust pipe; and
a diffuser having a front section, middle section, and rear section, with the diffuser encasing at least the combustion chamber and inlet pipe, with each section having a predetermined cross-sectional shape, and further with the front section having a first cross-sectional area, the middle section having a second cross-sectional area larger than the first cross-sectional area, and the rear section having a third cross-sectional area greater than the second cross-sectional area, and further with the diffuser being capable of reducing the velocity of an airstream input to the diffuser through the front section and transiting to the rear section during operation of the flight vehicle at low and high speeds/altitudes so that a predetermined amount of air can ingress the inlet pipe for mixing with the fuel being injected by the fuel injector.

2. The system as recited in claim 1, wherein the cross-sectional shape of the front section, middle section, and rear section of the diffuser includes a predetermined cross-sectional shape.

3. The system as recited in claim 2, wherein the diffuser includes a form in which the front section transitions to the wider middle section in a predetermined manner and the middle section transitions to the wider rear section in a predetermined manner.

4. The system as recited in claim 3, wherein the first direction includes a direction toward a rearward end of the flight vehicle.

5. The system as recited in claim 4, wherein the diffuser includes a form that decreases the velocity of the airstream input to the front section in a predetermined manner as such airstream transits from the front section to the rear section so that a predetermined amount of air will ingress the inlet pipe by substantially reversing the direction of the predetermined amount of air flow from the first direction to a second direction.

6. The system as recited in claim 5, wherein the diffuser includes a form that increases a level of static pressure in the diffuser in a predetermined manner as such air transits from the front section to the rear section for enhancing an ability of the predetermined amount of air to ingress the inlet pipe.

7. The system as recited in claim 6, wherein an open distal end of the rear section of the diffuser includes having connected thereto a deformable extension capable of changing the cross-sectional area of the open end of the rear section for adjusting the level of static pressure within the diffuser.

8. The system as recited in claim 1, wherein the cross-sectional shape of the front section, middle section, and rear section of the diffuser includes a circular or an oval cross-sectional shape.

9. The system as recited in claim 8, wherein the diffuser is integrated as part of a flight vehicle structure.

10. The system as recited in claim 1, wherein the diffuser encases at least the combustion chamber, the inlet pipe, and the exhaust pipe.

11. The system as recited in claim 10, wherein the cross-sectional shape of the front section, middle section, and rear section of the diffuser includes a predetermined cross-sectional shape.

12. The system as recited in claim 11, wherein the diffuser includes a form in which the front section transitions to the wider middle section in a predetermined manner and the middle section transitions to the wider rear section in a predetermined manner.

13. The system as recited in claim 12, wherein the first direction includes a direction toward a rearward end of the flight vehicle.

14. The system as recited in claim 13, wherein the diffuser includes a form that decreases the velocity of the airstream input to the front section in a predetermined manner as such airstream transits from the front section to the rear section so that a predetermined amount of air will ingress the inlet pipe by substantially reversing the direction of the predetermined amount of air flow from the first direction to a second direction.

15. The system as recited in claim 14, wherein the diffuser includes a form that increases a static pressure in the diffuser in a predetermined manner as such air transits from the front section to the rear section for enhancing an ability of the predetermined amount of air to ingress the inlet pipe.

16. The system as recited in claim 15, wherein an open distal end of the rear section of the diffuser includes having connected thereto a deformable extension capable of changing the cross-sectional area of the open end of the rear section for adjusting the level of static pressure within the diffuser.

17. The system as recited in claim 10, wherein the cross-sectional shape of the front section, middle section, and rear section of the diffuser includes a circular or an oval cross-sectional shape.

18. The system as recited in claim 17, wherein the diffuser is integrated as part of the flight vehicle structure.

19. The system as recited in claim 1, wherein air transiting from the front section to the rear section of the diffuser dissipates heat from, and cools, at least portions of the pulsejet engine disposed within the diffuser.
